(19) United States
(12) Patent Application Publication
(10) Pub. No.: US 2018/0036685 A1
(43) Pub. Date: Feb. 8, 2018

(54) Method for Fouling Reduction in Membrane Based Fluid-Flow Processes, and Device Capable of Performing Such Method

(71) Applicant: Redstack B.V., Sneek (NL)

(72) Inventors: Damnearn Kunteng, Leeuwarden (NL); Mathijs Van de Kamp, Harlingen (NL); Christiaan Haldir Goeting, Amsterdam (NL); Simon Grasman, Britsum (NL)

(21) Appl. No.: 15/551,534

(22) PCT Filed: Feb. 19, 2016
(86) PCT No.: PCT/NL2016/050124

§ 371 Date: Aug. 16, 2017

(30) Foreign Application Priority Data
Feb. 20, 2015 (NL) 2014329

(51) Int. Cl. B01D 65/08; B01D 65/02; B01D 61/52; B01D 61/42

(52) U.S. Cl. CPC B01D 65/08; B01D 61/422; B01D 65/02; B01D 61/52; B01D 2321/223; B01D 2321/2033; B01D 2313/14; B01D 2313/48

(57) ABSTRACT

The invention relates to a method for fouling reduction and/or fouling removal and/or prevention of fouling in membrane based fluid-flow processes, such as ED, RED, EDR, CDI, fuel cells, filtration, flow batteries, and a device capable of performing such methods. The method comprises the steps of: —providing a dynamic membrane stack with a number of membranes, the stack capable of changing the average inter-membrane distance between two adjacent membranes with the inter-membrane distance being the distance between the membrane surfaces of two adjacent membranes; —performing the membrane based fluid-flow process in a first state with the stack having a first set of average inter-membrane distances; —switching the membrane based fluid-flow process between the first state and a second state wherein the stack having a second set of average inter-membrane distances different from the first set; and —performing the membrane based fluid-flow process in the second state, wherein, at least in an initiating phase, fouling is removed and/or reduced and/or prevented.

The present invention relates to a method for fouling reduction and/or (in-situ) fouling removal and/or prevention of fouling in membrane based fluid-flow processes, such as electrodialysis (ED), electrode dialysis reversal (EDR), reversed electrodialysis (RED), electrodeionisation (EDI), capacitive deionisation (CDI), fuel cells, filtration including cross-flow filtration, (redox) flow batteries, capacitive energy generation systems.

From conventional membrane based fluid-flow processes it is generally known that fouling occurs. This fouling may involve bio-fouling, particle-fouling, colloidal-fouling, deposition of particles and components, cake-formation, gel layer etc. This fouling significantly reduces the overall performance of the process and the fouling increases with decreasing inter-membrane distances thereby further limiting the overall process efficiency.

To remove fouling, for example from a membrane surface in a filtration process, it is known to perform a back flush operation involving a short time period of flow reversal. Also air-flushing is used to remove colloidal particles from membranes and/or spaces, for example. In RED and ED(R) flow reversal (reversing the direction of the flow) and/or flow switch can be used, either switching the two feed solutions or switching the polarity in electrical driven processes causing a switch of the product solutions, for example to reduce fouling problems.

The problem is that conventional methods do not remove fouling sufficiently to operate membrane based fluid-flow processes over a long time period with an acceptable overall performance. Furthermore, these conventional methods are less effective in removing fouling in membrane based fluid-flow processes when decreasing the inter-membrane distances. While fouling increases with decreasing inter-membrane distances.

The present invention has as one of its objectives to provide a method that improves the overall performance of membrane based fluid-flow processes.

This objective is achieved with a method for fouling reduction and/or fouling removal including in-situ removal and/or prevention of fouling in membrane based fluid-flow processes according to the invention, the method comprising the steps of:
providing a dynamic membrane stack with a number of membranes, the stack capable of changing the average inter-membrane distance between two adjacent membranes with the inter-membrane distance being the distance between the membrane surfaces of two adjacent membranes;
performing the membrane based fluid-flow process in a first state with the stack having a first set of average inter-membrane distances;
switching the membrane based fluid-flow process between the first state and a second state wherein the stack having a second set of average inter-membrane distances different from the first set; and
performing the membrane based fluid-flow process in the second state, wherein, at least in an initiating phase, fouling is removed and/or reduced and/or prevented.

Membrane based fluid-flow processes include ED, EDR, RED, CDI, fuel cells, filtration and flow-batteries. A fluid includes a liquid, gas, slurry and/or mixtures thereof that may contain material of any type, including micro organisms, particles, inorganic and organic substances/material etc. Fouling may involve bio-fouling, particle-fouling, colloidal-fouling, deposition of particles and components, cake-formation, gel-layer etc.

Membrane based processes involve a membrane stack comprising of a number of membranes, with the number being one or more. The membrane stack acts as a device configured for performing membrane based fluid-flow processes. One or more fluid flows are supplied to the fluid compartments that are defined between adjacent membranes. Adjacent membranes are positioned at a distance of each other to provide a flow compartment between two adjacent membranes. This inter-membrane distance is the distance between the membrane surfaces of two adjacent membranes. The average inter-membrane distance is the inter-membrane distance averaged over the entire surface area of the membrane that is in contact with the fluid.

According to the present invention a dynamic membrane stack is a membrane stack which is specifically designed to be able to change the inter-membrane distance in an active and controlled manner. In a presently preferred embodiment this is achieved by controlling the pressure difference between the feed solutions, which enables the dynamic change of inter-membrane distance and thus preventing and/or removing fouling and improving general performance. By enabling a further decrease in inter-membrane distances, without the increase of the risk of fouling. an optimized performance can be achieved.

By providing a dynamic membrane stack, the average inter-membrane distance between two adjacent membranes can be changed, preferably in a controlled manner. This may involve changing the shape, configuration and/or orientation of adjacent membranes, thereby changing the dimensions and/or volume of the fluid-flow compartment(s) between the membranes. For example, the configuration of the membrane changes from a substantially convex to a substantially concave shape with the inlet and outlet being maintained at substantially the same position due to fluid entry and exit. This changes the volume of the fluid-flow compartment.

In a further preferred embodiment of the invention the membrane distance between two adjacent membranes, the inter-membrane distance, varies considerably between the first and the second state. In preferred embodiments, defining the combined membrane distance (Dc) as the sum of the adjacent membrane distances (Da and Db), in a first state Da is responsible for about 0.1-40%, and preferably 1-25%, of Dc, while Db is responsible for the remainder of Dc. In a second state Db is about 0.1-40%, and preferably 1-25%, of Dc, while Da is responsible for the remaining 60-99.9%. The range of 1-25% is a preferred range. Other preferred ranges are 2-25%, 5-20% and 10-20%. Preferably, the stack dimensions remain substantially the same when switching between different states having different sets of average inter-membrane distances.

Preferably, varying the inter-membrane distances is achieved by providing a pressure difference between the two sides of a membrane, also referred to as the differential pressure. For example, the flows to the adjacent fluid compartments are supplied at different pressures.

For example, in a first state the pressure of a first flow in a first compartment having a relatively high salt concentration is higher as compared to the pressure of a second flow in a second adjacent compartment having a relatively low salt concentration. This pressure difference in adjacent fluid compartments is responsible for different inter-membrane distances of the adjacent fluid compartments. In a second state the flows are switched such that the first flow is in the second compartment and the second flow is in the first compartment. By keeping the pressures of the flows before and after the switching about the same, the membrane between the adjacent fluid compartments is confronted with a different pressure difference such that the inter-membrane distances of the adjacent fluid compartments change. This leads to the dynamic membrane stack according to the present invention. It will be understood that for ED(R) switching between states involves a polarity switch, with the diluate preferably being maintained in the (thinner) compartment. Due to changing pressure differences of the flows the inter-membrane distances can be changed when switching between different states.

A dynamic stack involves a set of average inter-membrane distances with individual average inter-membrane distances being the average inter-membrane distance between two adjacent membranes of the dynamic stack. Changing the average inter-membrane distances enables performing a membrane based fluid-flow process in a first state with a stack having a first set of average inter-membrane distances. After a certain time period and/or after detecting too much fouling or a decrease in overall performance, the membrane based fluid-flow process is switched to a second state wherein the stack having a second set of average inter-membrane distances different from the first set and performing a membrane based fluid-flow process in the second state, wherein, at least in an initiating or a starting phase, fouling is removed and/or reduced and/or prevented. By removing, reducing and/or preventing the fouling, the overall performance of the process increases again. Preferably, after every switch providing a change in the average inter-membrane distance, at least in the initiating phase fouling is removed or reduced. More specifically, increasing the average inter-membrane distance for one of the compartments, allows for the removal of fouling accumulated in the previous state where the compartment had a lower average inter-membrane distance.

Furthermore, the method for fouling reduction and/or removal and/or prevention according to the present invention can be performed when the process is in use and does not require huge maintenance efforts, for example including dismantling the device. Therefore, the method according to the present invention can be performed in-situ and increases the time period wherein the process can be performed. This improves the overall process performance including economic performance.

A further effect of varying the average inter-membrane distance is that the form of a membrane dynamically changes during the process. This enhances the brake-off of fouling, such as particle-fouling, bio-fouling, cake layers etc. This provides an additional fouling reduction and/or removal and/or prevention in membrane based fluid-flow processes, thereby rendering the fouling removal and/or removal and/or prevention very effective and efficient.

Actively changing the inter-membrane distance according to the present invention can be monitored in case of electro-membrane processes by measuring resistances and changes therein, for example. These measurements indirectly provide information of changes in actual inter-membrane distances.

Also, the dynamic stack according to the present invention is capable of improving removal of gas bubbles. This enhances the overall process performance.

Furthermore, varying inter-membrane distances may have advantageous effects on other operations, such as capacitive (energy) devices that can more effectively be made asymmetric in relation to width/length, compartment dimensions such as thickness, flow rates, etc. Also, de-airing and/or removing air-bubbles is easier, reduction of resistance, fouling is possible, thereby increasing overall process performance. Furthermore, the performance can be improved as one compartment can have lower resistance. Moreover, the spacers can be made at lower cost thereby improving the economic performance.

The method according to the present invention can be applied to different configurations of membrane based fluid-flow processes. Such configurations include parallel co-flow, cross-flow, parallel counter-flow. In one of the presently preferred configurations according to the invention use is made of spacer modules, as will be described in more detail in this application, optionally with spacer netting and more preferably without spacer netting, in a cross-flow setting, with fluid flows being directed in the plane of the membranes of the stack in (parallel) co-flow and in counter-flow configurations, for example. Optionally, a configuration according to the invention can be applied with or without side plates to supply and/or discharge flows.

Preferably, switching the membrane based fluid-flow process from a first state to a second state involves a flow-switch. After such flow-switch fluid that was flowing to a first compartment is in the second state provided to a second compartment, while the fluid that was flowing through the second compartment in the first state is preferably supplied to the first compartment in the second state. Optionally, alternatively to and in one of the possible embodiments preferably in combination with the flow-switch, also the flow direction of one or more fluid flows can be reversed. This further enhances the removal and/or reduction and/or prevention of the fouling in the membrane based fluid-flow processes. Optionally, flow-switch and/or flow reversal are combined with other anti-fouling measures, such as air cleaning/sparging when performing the switch/reversal. Increasing the average inter-membrane distance further enables an in situ fouling removal, such that fouling can be removed more efficiently. Optionally, other fluids can be applied in the second state, preferably just before, at and/or just after switching between the different states. For example, air is supplied to enable air-sparging in this second state, more specifically during switching. Also, a conventional back flush can be used in combination with the dynamic stack according to the invention to improve the fouling removal and/or reduction and/or prevention. Furthermore, when applying a flow-switch in electro-membrane processes the current reverses, current-reversal. This also contributes to the removal and/or reduction and/or prevention of fouling. It will be understood that in EDR-processes polarities and flow pressures are changed when switching between different states.

Flow-switching with or without flow reversal further enables an in situ fouling removal, such that fouling can be removed more efficiently. Optionally, other fluids can be applied in the second state, for example air to enable air-sparging in this second state. Also, a conventional back flush can be used in combination with the dynamic stack according to the invention to improve the fouling removal and/or reduction and/or prevention.

In a presently preferred embodiment according to the present invention, the method further comprises the step of providing a differential pressure over a membrane in the range of 0.1-500 mbar, preferably 0.1-100 mbar, more preferably 0.1-50 mbar, and most preferably 0.1-25 mbar.

In the context of the present invention providing a differential pressure over a membrane involves providing a differential pressure between adjacent compartments that are separated by a membrane. By providing a differential pressure over a membrane provides a driving force for the flexible membranes to take a different position and/or orientation in the membrane stack, thereby varying the inter-membrane distance. The differential pressure that is applied when changing the average inter-membrane distance may depend on the type of fluids, the flexibility of the membrane, the (geometric) configuration of the membrane, membrane characteristics including the flexibility. An unnecessary and/or too high differential pressure could result in undesired leakage problems, requires more pump energy and may reduce the lifespan of the membrane. The differential pressure that is applied will change when switching between the first and second states. At least the sign of the differential pressure is different. Optionally, the value of the differential pressure may be changed also.

Varying the inter-membrane distance in a dynamic membrane stack means that the average inter-membrane distance in a first compartment is increased while the distance in another, preferably adjacent, compartment is reduced. The overall stack dimensions remain substantially constant during the entire process, also when switching between a first and a second state. As a further effect decreasing the inter-membrane distance increases the performance of the process. Especially when decreasing the inter-membrane distance of the compartments with the diluate solution in electro-membrane processes, since the diluate is generally the highest internal resistance barrier. This further improves the overall process performance.

In a presently preferred embodiment according to the present invention, in use, the switching is performed in a time interval of 0.1-180 hrs, preferably 2-48 hrs, most preferably 4-24 hrs. The actual interval may depend on fouling level and/or fouling rate.

It is shown that in most membrane based fluid-flow processes a switching interval in the range of 2-48 hrs, and preferably in the range of 4-24 hrs, is sufficient to reduce and/or remove and/or prevent fouling to an acceptable level and keeping the overall performance of the process at an acceptable level for most types of fluid and membrane based processes. Switching may involve switching flows and/or flow directions of one or more of the fluids.

For filtration applications, in use, the switching is performed in a time interval of 0.01-168 hrs, preferably 0.1-48 hrs, and most preferably 0.2-24 hrs.

It should be noted that the duration of the operation in a first state and a second state may be different. For example, in case the first state relates to the normal operation it may have a duration of 23 hrs, while in the second state the duration may be limited to a smaller time period, for example 1 hr. As an example, in filtration operations, the first state may relate to the normal operation which is typically about 0.1-4 hrs, while the second state may relate to a flow reversal, also referred to as a back flush or back wash of about 1/3600 hr-1 hr.

It is shown that the method according to the present invention can be advantageously applied to so-called electro-membrane processes such as ED, EDR, RED, and use electro compartments comprising electrodes including capacitive electrodes.

In a further preferred embodiment according to the present invention, the method comprises the step of providing a stack configuration comprsing a spacer module capable of handling varying average inter-membrane distances.

Conventional spacers, specifically conventional net-spacers, require a so-called woven net and a gasket, for example an integrated gasket. These conventional spacers are very sensitive towards fouling, specifically particle fouling, and in use may have relatively high hydraulic pressure losses such as frictional and/or viscous losses, thereby reducing the overall performance of the process. Furthermore, these conventional spacers are relatively expensive, thereby reducing the overall economical performance of membrane based fluid-flow processes.

Providing a spacer module according to a preferred embodiment of the present invention reduces fouling and/or removes/prevents fouling, and, in addition, provides efficient means to deal with the varying average inter-membrane distances in the dynamic stack. In a presently preferred embodiment of the invention this is achieved by providing a varying thickness of the spacer module over the stack in the flow direction. More specifically, the spacer module is thicker at the flow inputs/entrances to the compartments and provides a thinner support in the middle of the compartment. Preferably, this support in the middle section of the compartment defines the minimal inter-membrane distance. The support may involve woven spacers, extruded spacers, flow spacers and profiled membranes. Therefore, the preferred spacer module is thicker at the flow input/entrance and thinner in the middle section of the compartment. This minimal thickness defines the minimal inter-membrane distance. This enables a dynamic membrane stack allowing controlled changes of the (average) inter-membrane distances. Furthermore, the spacer module according to such embodiment of the present invention has lower pressure drop, lower manufacturing costs, improved gas bubble removal, and improved air sparging. Preferably, the spacer module between two adjacent membranes comprises a base spacer, or in one of the embodiments a flow spacer, and at least one additional open spacer, even more preferably at least two open spacers. It is shown that such specific configuration for the spacer module according to the present invention is capably of being used in the dynamic membrane stack.

Optionally, the use of open spacers provides a bridging function thereby preventing the membrane being pressed into the inlets and/or outlets. Especially with specific design of the dimensions of the open spacers, such as the size of the edges, the bridging function can be achieved. This has the advantage of requiring little handling, reduction of stack building time, and relatively cheap production.

Also, an open spacer may provide additional support. The spacer module may comprise of one base spacer, preferably a flow spacer. In one of the simplest embodiments the spacer module comprises one base spacer, preferably a flow spacer comprising at least one flow channel. This flow spacer may consist of more than one layer, for instance to allow for a bridge function. Also more than one layer can be used, especially for practical reasons, for example to vary thickness of the flow compartment if required. Other embodiments comprise at least one base spacer/flow spacer and at least one open spacer, but preferably two open spacers, one on each side of the base spacer. Also, for example for upscaling, a higher number of open spacers can be applied. This contributes to the modular approach of the spacer module according to the invention. Furthermore, a higher number of spacer modules can be applied, for example in such a manner that only one set of end-plates is required containing more than one spacer modules next/parallel to each other. This contributes to the modular approach of stack design/building according to the invention.

The spacer module according to the invention is more cost effective as compared to conventional spacer solutions, such as net-spacers. Estimated cost-reduction can be as high as a 90% reduction. The spacer module can be produced with high volume production methods, such as (rotary) die-cutting, injection molding, thermoforming, for example. These high volume production methods reduce costs. Also, the spacer can be made from relatively cheap foil materials, such as LDPE for example, which have good thickness tolerances required for spacers, especially for preventing leakage. It will be understood that good tolerances are of upmost importance to prevent fluid leakage. The invention also allows for flexibility in design of the spacers, enabling to tailor-made solutions for each application. The present invention can already at relatively low pressure be applied advantageously, thereby reducing leakage risks and performance reduction. In addition, this reduces the requirements for individual spacer components thereby enabling the use of cost-effective spacers/spacer components.

The present invention also relates to a device for performing a membrane based fluid-flow process, wherein the device is capable of performing the method as described earlier.

The device provides the same effects and advantages as those stated for the method as described above.

In a preferred embodiment, the dynamic membrane stack having a number of membranes is capable of changing the (average) inter-membrane distance between two adjacent membranes, wherein a spacer module is provided that is configured for enabling varying the average inter-membrane distance. Preferably, the spacer module defines the minimal inter-membrane distance with the minimal support thickness in the middle section of the compartment. Varying the inter-membrane distance improves the overall performance of the process.

In a presently preferred embodiment, a spacer module between two adjacent membranes comprises a flow spacer and at least one additional open spacer on each side of the membrane, preferably two open spacers. The flow spacer or base spacer, which can also be referred to as normal spacer, can be made from a highly perforated substrate with a sealing gasket and/or edge with sealing properties. The perforations can have any geometrical shape, such as triangles, rectangles, holes etc. with a typical hydraulic diameter of 0.1-50 mm. General width of the channels in the flow spacers are typically in the ranges of 1-50 mm, the width of the ridge between the channels is in the range of 0.1-25 mm. The fluid inlet(s) and outlet(s), also referred to as supply and discharge means, have a diameter in the range of 0.1-50 mm. Especially in case of so-called electro-membrane processes such as ED, EDR, and RED, these inlets and outlets should preferably be sized relatively small to reduce undesired ionic shortcut currents and/or reduce losses due to ionic shortcut currents. This is specifically true if more than one, for example more than 20, cells are used, because losses due to ionic short-cut currents increase steeply with increasing number of cells. In addition, the dimensions of the inlets and outlets should also not be too small because this may cause hydraulic losses (frictional and/or viscous losses) and would become more sensitive towards fouling.

Spacer material is preferably cheap, has sealing properties, and may include PE, LDPE, flexible PP (FPP), EVA, rubber, silicone, and similar materials. Spacers, especially base/flow spacers, can also be made from ion conductive materials, for example membranes, and/or porous materials. In electro-membrane processes such as ED, EDR, RED, ion conductive materials and porous materials have the advantage that this will reduce the internal stack resistance because more effective surface area is available, thus enhancing overall performance. When porous materials are used, a sealing edge could optionally be provided to prohibit leakage. With the use of ion conductive material all parts of the spacer (module) are ion conductive. This is especially relevant when used in electro-membrane applications, such as ED, EDR and RED. The spacers can be produced with (rotary) dye-cutting, using a cutting plotter, laser cutting, water cutting, ultrasonic cutting and welding, thermo-forming, (hot) embossing, CNC-machining, injection moulding, 3D-printing etc. This enables providing spacers that are more cost effective as compared to conventional spacers.

In an alternative embodiment profiled membranes can be used to introduce the appropriate flow compartment, such that the use of spacers is reduced or spacers can be omitted from the device.

The thickness of the spacer material of individual spacers, such as base/flow spacer and open spacer, is typically in the range of 0.01-10 mm, width of gasket sealing area dimensions in the range of 0.05-100 mm, preferably 0.1-50 mm, and more preferably 1-25 mm wide. Gasket sealing area should be optimized taking into account among others, inlet/outlet dimensions, proper sealing function, proper support function, and cost-effective use of spacer module and membranes. Channels can be designed in numerous ways, for example involving straight channels, serpentine channels, repetitive venturi-shaped channels, or combinations thereof. Also, the flow spacer may comprise a porous active area, made of woven extruded or non-woven material, optionally perforated with perforations having different shapes like holes, grooves, slits etc. The spacer parts can be bonded together by laminating, welding, gluing, hot pressing etc. In addition, the spacer can be bonded to the membranes by (ultrasone)welding, gluing, etc.

The open spacers may have a configuration with manifold holes for inlets and outlets to enable supply and discharge of fluid to the compartment, and an alternative configuration wherein the manifold holes are closed and not open to the channel so that the fluid is supplied and discharged through the base/flow spacer only. The sealing edge and/or gasket of the open spacer in such configuration acts as a bridge-element or bridge-configuration thereby achieving a bridging function providing more support preventing a membrane being pressed into the inlets and/or outlets of the spacer module that would reduce and/or prevent the flow and/or increase fouling probability, as mentioned earlier.

Further advantages, features and details of the invention are elucidated on the basis of preferred embodiments thereof, wherein reference is made to the companying drawings in which:

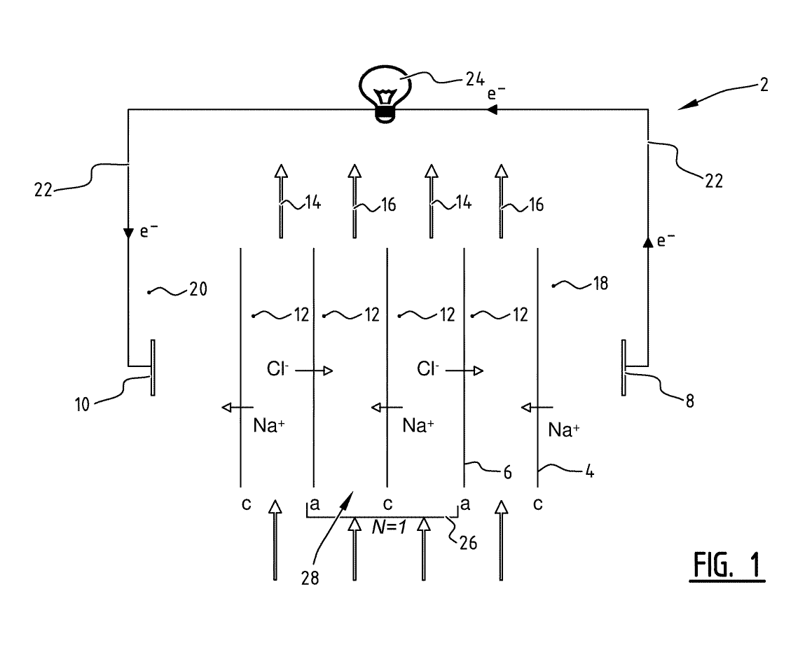

FIG. 1 shows a schematic overview of a device according to the invention for performing a reverse electrodialysis process;

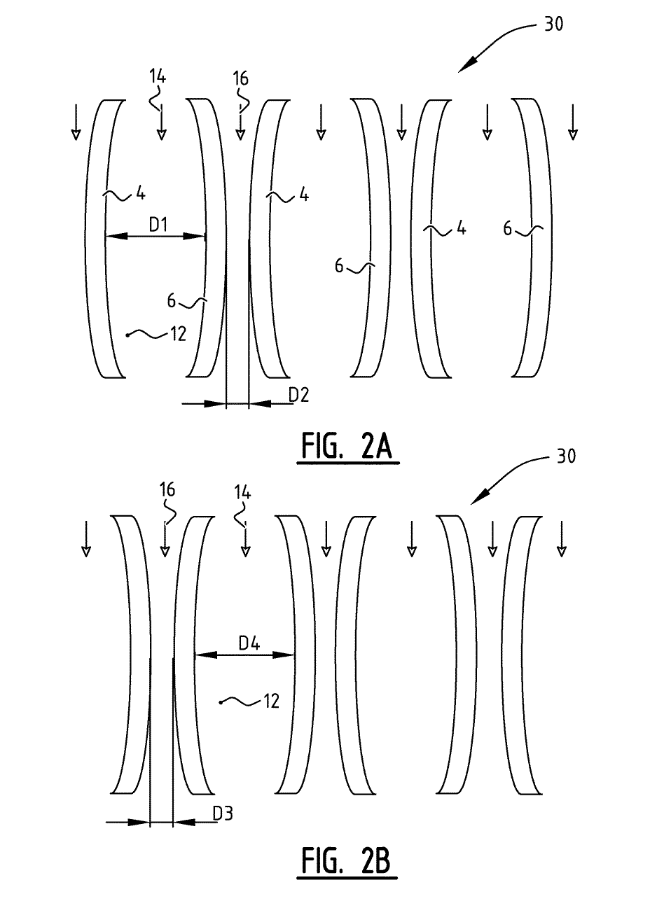

FIGS. 2 A and B shows two states of a dynamic stack according to the invention;

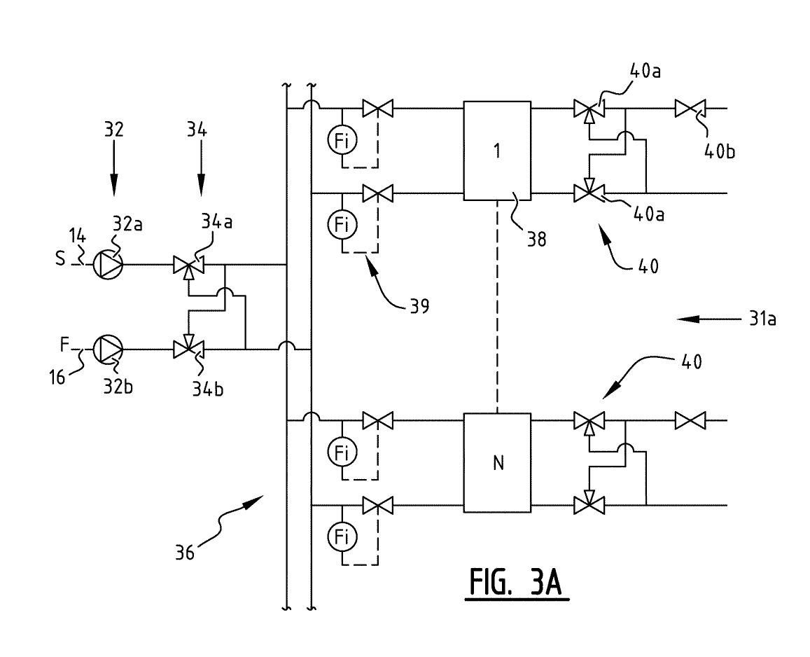

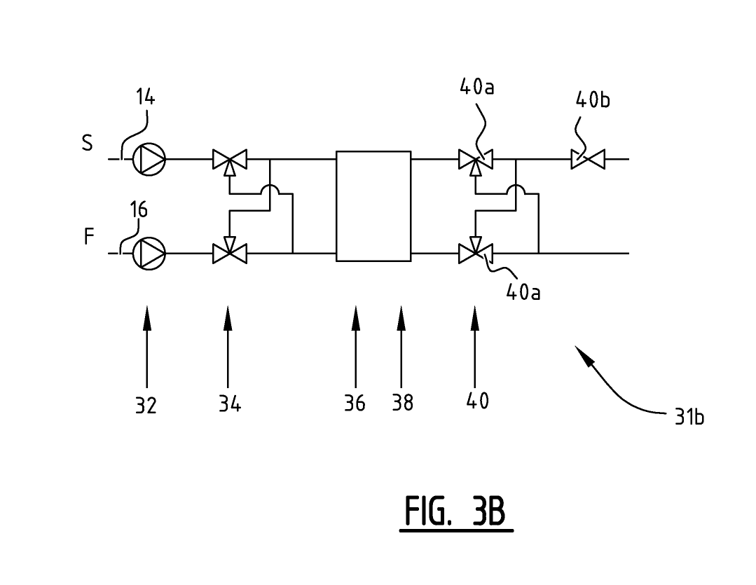

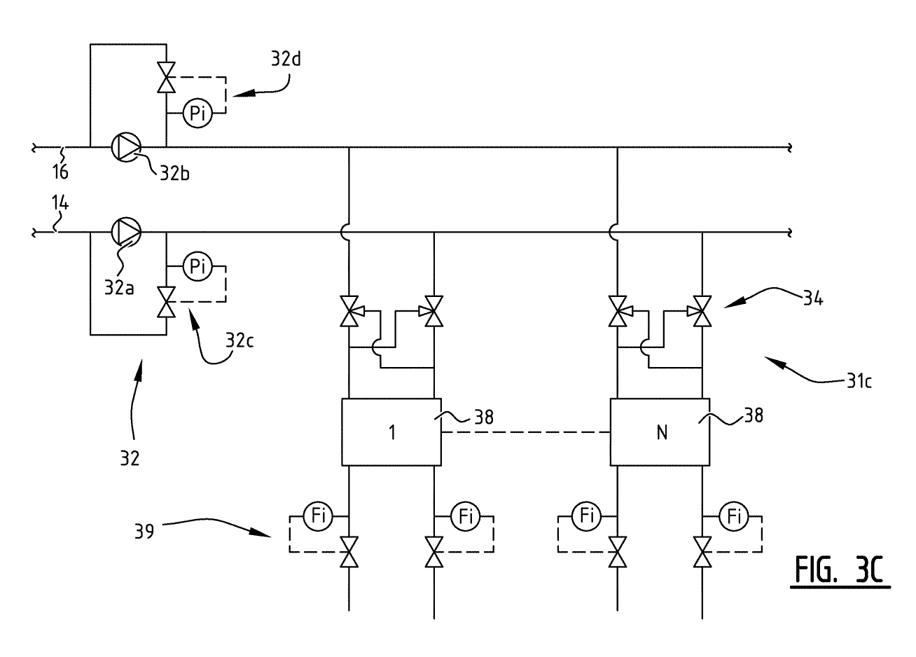

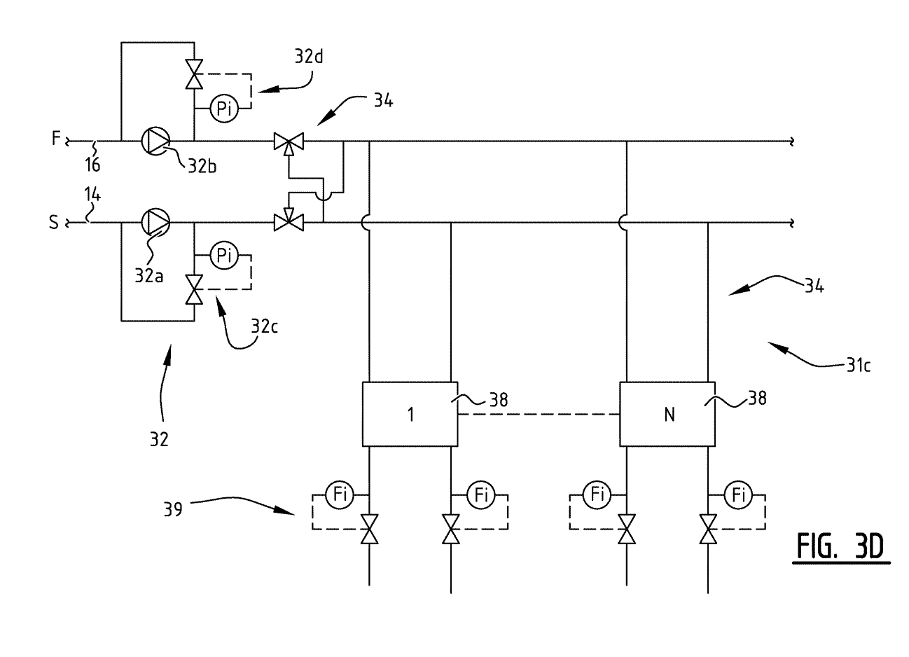

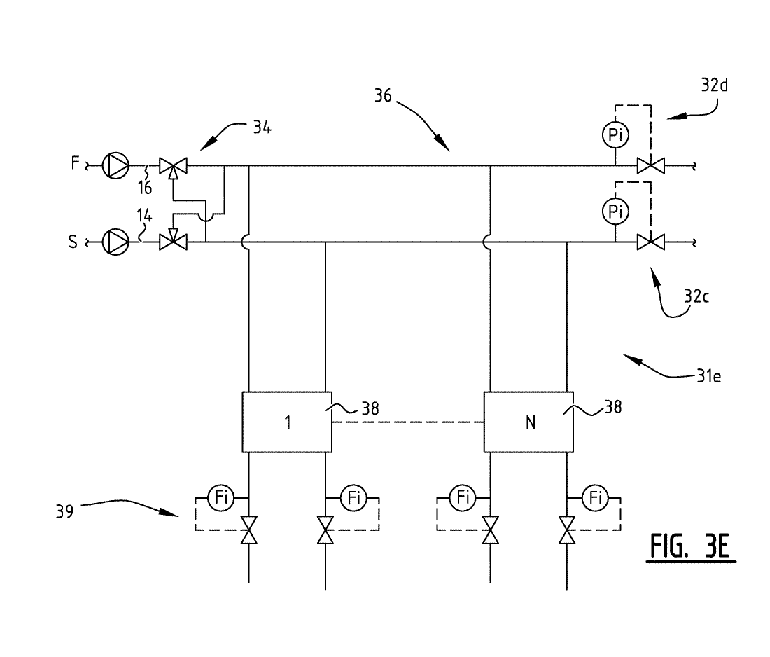

FIG. 3 A-E shows a schematic overview of a process with a switching mechanism according to the invention;

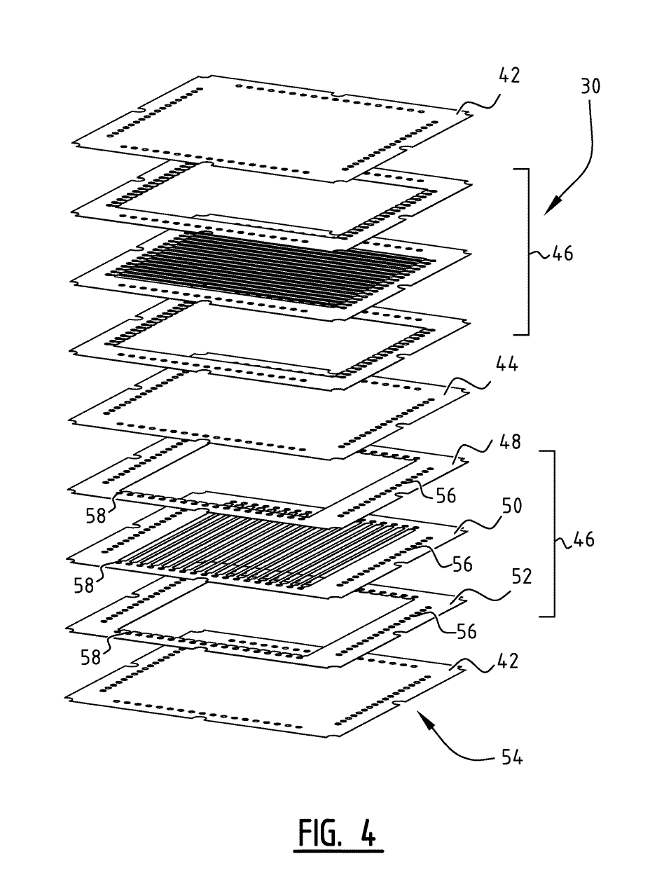

FIG. 4 shows a spacer module and membranes in a dynamic membrane stack according to the invention;

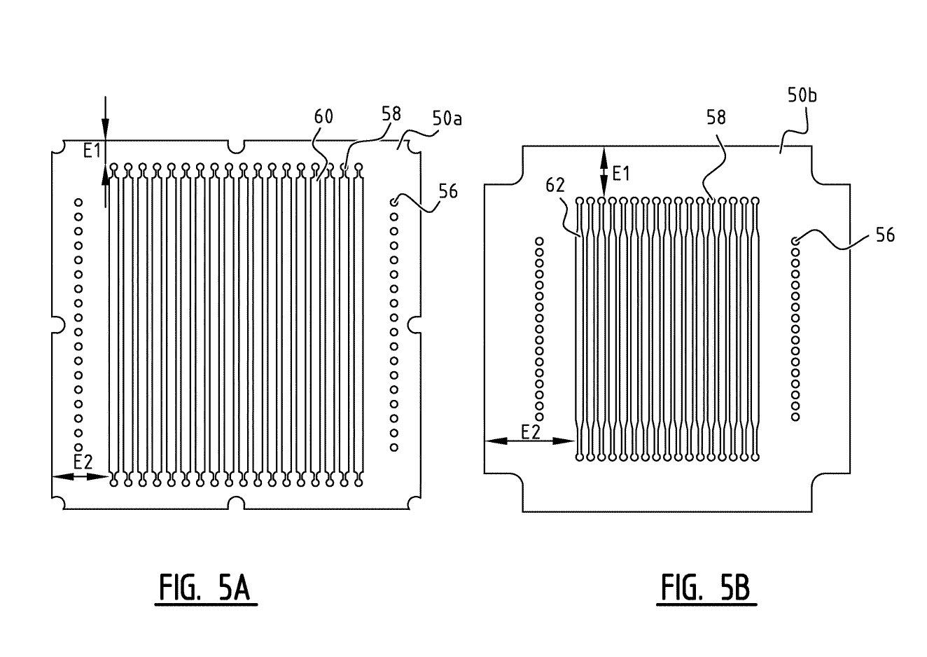

FIGS. 5 A and B shows two configurations for a spacer of the spacer module of FIG. 4;

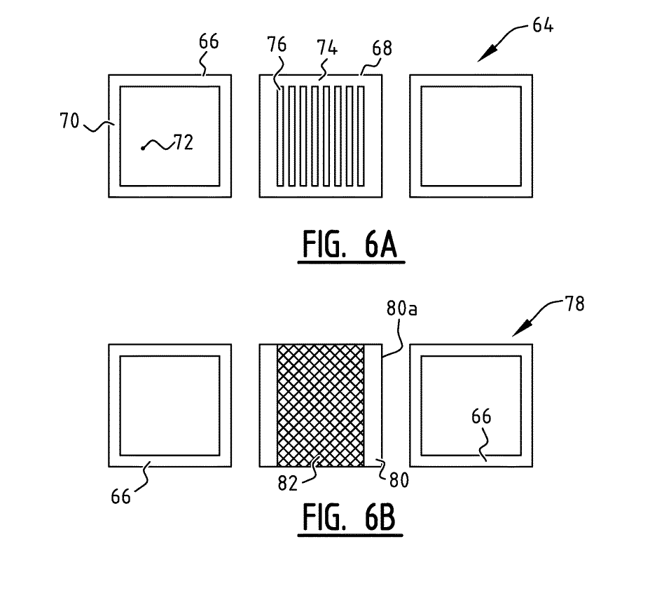

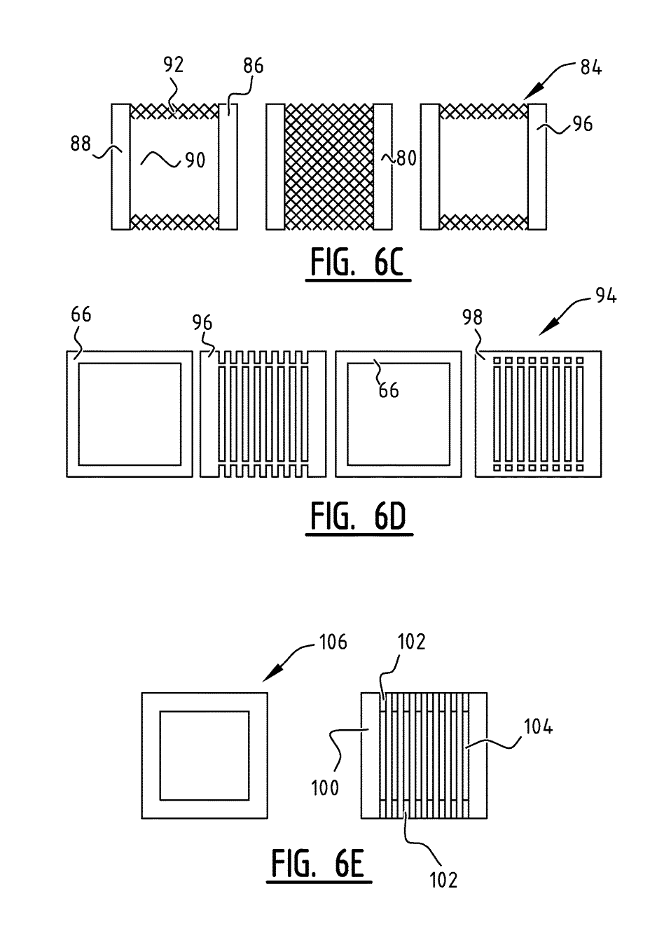

FIG. 6 A-E shows different embodiments of the spacer module of FIG. 4;

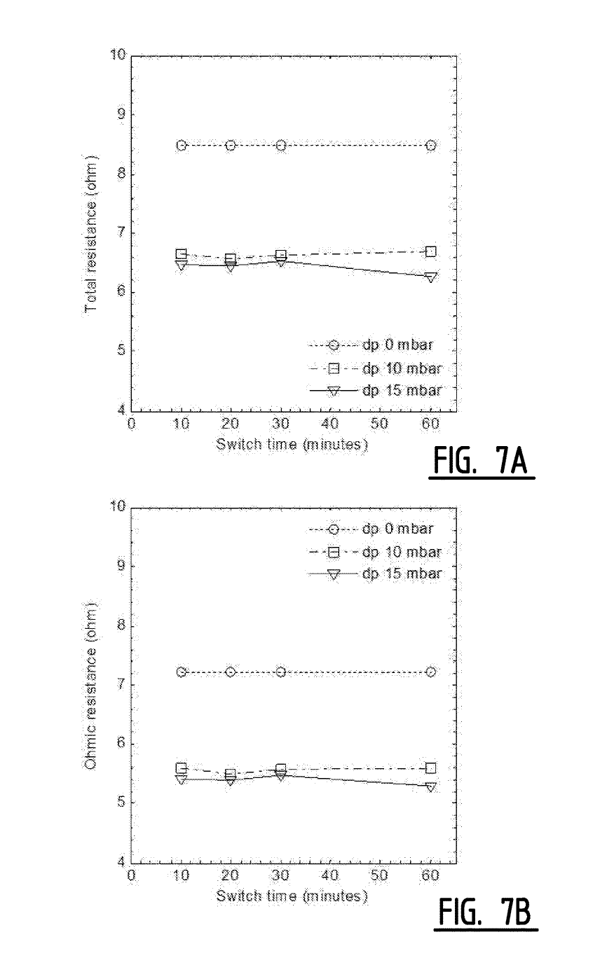

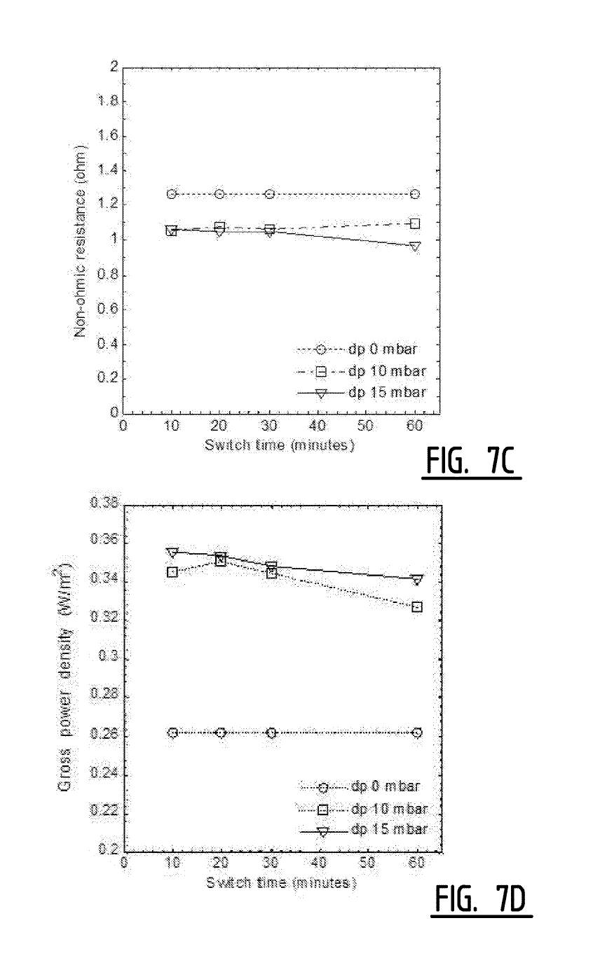

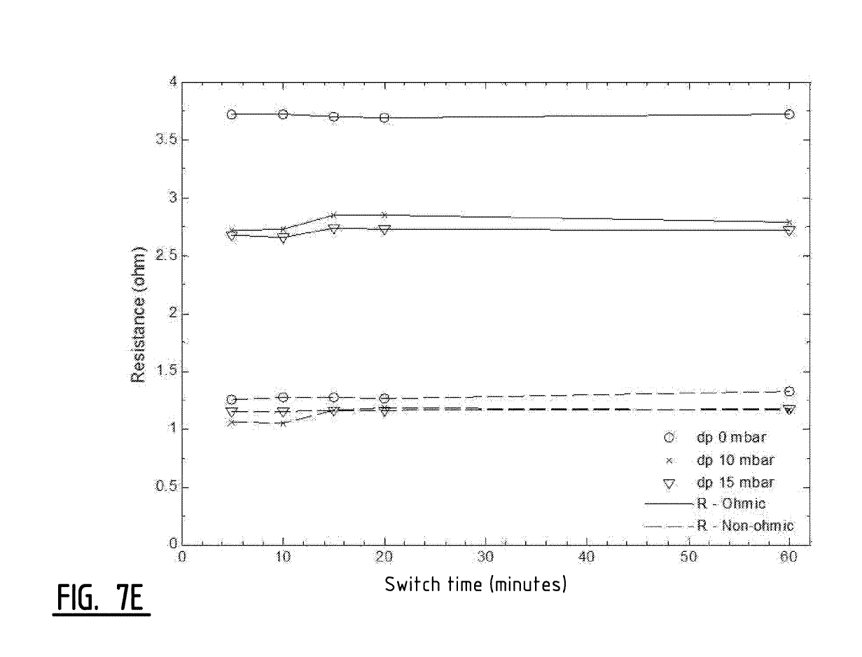

FIG. 7 A-E shows some experimental results; and

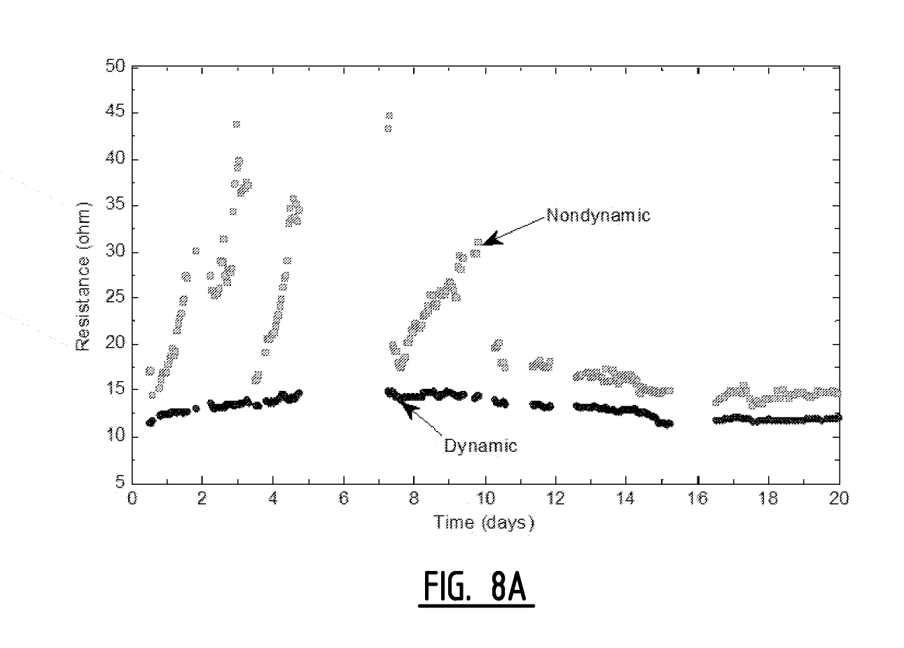

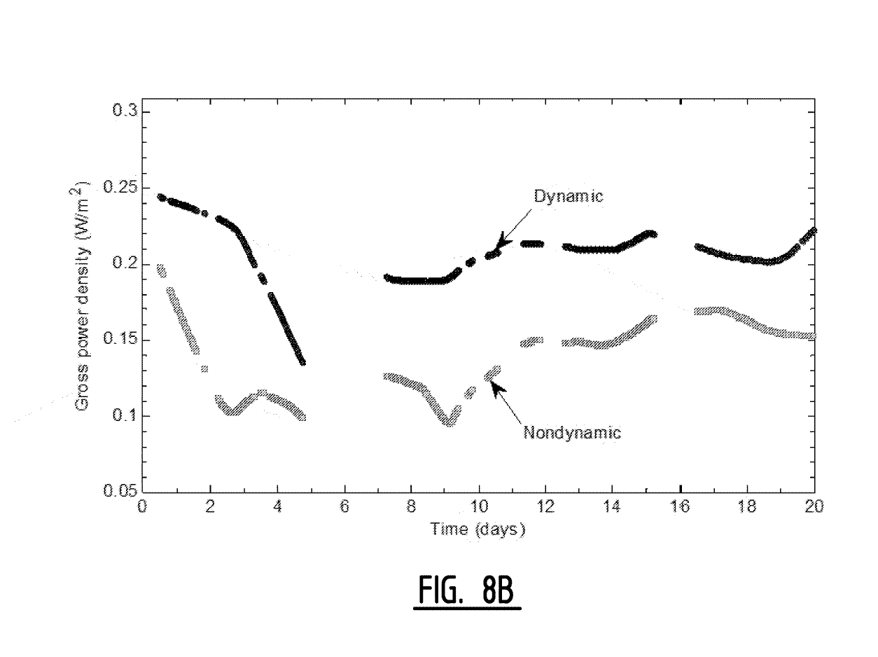

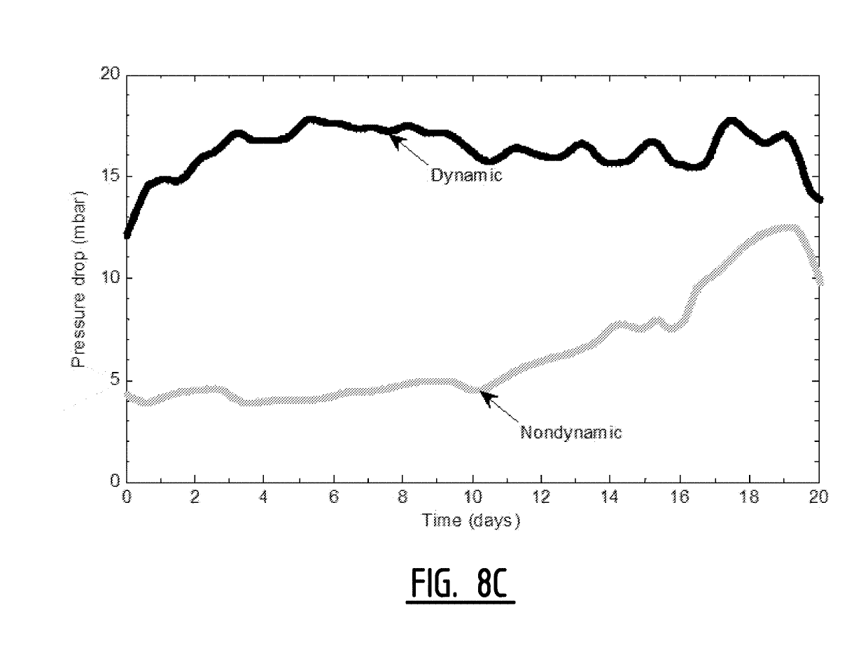

FIG. 8 A-C shows some further experimental results.

FIG. 1 schematically shows an overview of a reversed electrodialysis process with device/system 2. As may be seen in FIG. 1, a number of cation exchange membranes 4 and anion exchange membranes 6 are placed between first electrode 8 and second electrode 10. Electrodes 8, 10 can be conventional electrodes and/or involve other types of electrodes including one or more capacitive electrodes. Between anion exchange membranes 6 and cation exchange membranes 4 fluid flow compartments 12, to which is sometimes also referred as electrolyte compartments, are formed, wherein alternatingly a fluid with a relatively high salt concentration 14, such as seawater, with relatively high salt concentration, and a fluid with a lower salt concentration 16, such as river water, flows in a co-flow configuration. It will be understood that a counter-flow configuration would also be possible in according with the present invention. Due to the concentration differences of ions in the sea water 14 and river water 16, the ions in the sea water 14 will be subjected to a driving force to move to the river water 16, to level the concentrations. For simplicity, in FIG. 1 only sodium (Na⁺) and chlorine (Cl⁻) ions are presented as positive and negative ions.

As anion exchange membranes 6 only allows anions to pass and the cation exchange membranes 8 only allow cations to pass, transport of anions and cations will proceed in opposite directions, The anions (Cl⁻) will move in the direction of first electrode 8 acting as anode, and the cations (Na⁺) will move in the direction of second electrode 10 acting as cathode. In order to maintain electric neutrality in the compartment(s) 18 where the electrode acting as anode 8 is placed, an oxidation reaction takes place, and in the compartment(s) 20 where the electrode acting as cathode 10 is placed, a reduction reaction takes place. Hereby a flow of electrons is generated in electric circuit 22 that connects electrodes 8, 10. In electric circuit 22 electric work is performed by electric apparatus 24, here symbolically presented by means of a bulb.

In the illustrated embodiments electrodes 8, 10 act as anode and cathode. It will be understood other embodiments can also be envisaged in accordance with the present invention. For example, in one such embodiment electrodes 8, 10 act as capacitive electrodes. It is noted that for the use of capacitive electrodes, redox reactions such as oxidation and reduction are not necessarily required to maintain electric neutrality.

In FIG. 1, a cell 26 is formed from a membrane couple 28 of an anion exchange membrane 6, a cation exchange membrane 4 and a mass of a solution having a high electrolyte concentration and a solution having a low electrolyte concentration (r). The number (N) of dialytic cells 24 (here N=1) may be increased to increase the potential difference between anode 8 and cathode 10.

In an ED(R) application a similar device 2 can be used with a power source instead of apparatus/bulb 24. In a filtration application circuit 22 and electrodes 8, 10 in compartments 18, 20 can be omitted, and the device can be used for (cross-flow) filtration, for instance for microfiltration, ultrafiltration and nanofiltartion processes. Such a device is also known as a plate- and frame cross-flow filtration unit. A fluid flow A is supplied to the compartments that are separated by membranes 4, 6 and leaves as fluid C, the so-called retentate. The retentate is often recycled back into the feed, often via a buffer tank. Fluid B, the so-called permeate, is transferred through the membrane and exits the stack at least at one side thereof. It will be understood that in a filtration application the membranes relate to membranes suitable for filtration and not to ion exchange membranes.

Dynamic stack 30 (FIGS. 2 A and B) comprises membranes 4, 6 defining fluid flow compartments 12. In the illustrated embodiment a parallel flow configuration is shown. In a first state (FIG. 2A) fluid 14, for example sea water, flows in a first compartment with a large maximum inter-membrane distance D₁, and also a larger average inter-membrane distance, and fluid 16, for example river water, in a second adjacent compartment with a smaller maximum inter-membrane distance D₂, and also a smaller average inter-membrane distance. This results in a first set of average (and maximum) inter-membrane distances. In a second state (FIG. 2B) the flows 14, 16 have been switched. Due to the changed partial pressures/differential pressures inter-membrane distances also change with maximum inter-membrane distances D₃ and D₄, respectively. This results in a second set of average (and maximum) inter-membrane distances that is different from the first set. It will be understood that other configuration are also possible, such as a counter-flow embodiment. Furthermore, it should be noted that in an embodiment with bended membranes, these membranes may not have a perfect symmetrical parabolic type of shape and the differential pressure can be different at the inlets and the outlets, which may result in an asymmetric bending. It is even possible that, with a very flexible membrane and high enough differential pressure the membrane substantially takes the shape of the open spacer compartment.

In the illustrated embodiment D₂ and D₃ are defined by the thickness of the membrane separating element, for example the distance holder, for example the base spacers or profiled membranes. These distances D₂ and D₃ limit the maximum changes in membrane position. Also, in the illustrated embodiment it will be understood that D₁+D₂=D₃+D₄. Furthermore, in the illustrated embodiment the inlet/outlet openings in the embodiment of FIG. 2 is defined by the configuration of the spacer module having a thickness in the range of D₂ (=D₃) and 0.5×(D₁+D₂).

In a filtration application stack 30 is in a similar manner provided with membranes 4, 6, preferably comprising membranes suitable for filtration and not necessarily comprising ion-exchange membranes, and supplied with fluid A. Permeate B and retentate C are the outputs of stack 30, and permeate B is transported through the membranes from one compartment 12 to the neighbouring compartments. Membranes 4, 6 behave in a similar manner as illustrated in FIGS. 2A and B, resulting in a dynamic filtration stack.

In an illustrated embodiment 31a pump system 32 (FIG. 3A) comprises two pumps 32a, 32b to supply fluid flows with high and low salt concentrations, for example. Switching mechanism 34 with valves 34a, 34b directing the fluid flows to the desired input(s) of header 36 that divides the flow(s) over N stacks 38. In the illustrated embodiment every stack 38 is provided with a flow controller 39. After stacks 38 there is provided valve system 40 directing the flows to their respective output channel. In the illustrated embodiment valve system 40 comprises regular valves 40a and, in addition, spring return valve 40b in the fluid flow with high salt concentration to control the (higher) pressure of the fluid flow with high salt concentration. Another number and/or type of valves 34, 40 may also be applied. In an alternative embodiment 31b (FIG. 3B) the flow is controlled by pump system 32, instead of flow controller 39.

Further alternative embodiments 31c, 31d, 31e (FIGS. 3C-E) show configurations wherein pressure is controlled at the entry side of stack(s) 38. This has the advantage that the larger (salt) compartment exhibits a lower pressure drop. This assures an overpressure over the entire length of the compartment. Pump system 32 comprises pressure controllers 32c, 32d involving recirculation over pump 32a, 32b. Switching system 34 can be provided separately for an individual stack 38 (FIG. 3C) or centrally for all stacks 38 (FIG. 3D). The flow is controlled with flow controllers 39 at the exit side of stacks 38 (FIGS. 3D-E). Embodiment 31e (FIG. 3E) is similar to embodiment 31d with the exception that the pressure in embodiment 31e is controlled at the exit of header 36.

It will be understood that other type of fluids and/or other configurations according to the invention are also possible, including counter flow and cross-flow configurations. Furthermore, additional pumps or one pump alternately activated for one of the fluid flows 14, 16 can be used. Also, suction pumps can be used that are provided after the stack. Another number and/or type of valves 34, 40 may also be applied. Also, other positions of components are possible, for example providing flow controllers 39 at the entry and/or exit side of stack(s) 38. It will be understood that the same principles as mentioned for electro-membrane processes may also apply to other membrane processes, such as filtration processes.

In the (electro)-membrane based fluid-flow processes such as ED, RED, EDR membranes 6, 8 preferably relate to ion exchange membranes, including anion exchange membranes (AEMs) and cation exchange membranes (CEMs) that can be stacked alternately in the dynamic membrane stack. As an example a RED process will be discussed in more detail. In a RED process the concentrated and diluted salt solutions 14, 16 are alternately provided to adjacent fluid flow/electrolyte compartments 12 and the produced voltage over each membrane 6, 8 is accumulated with both at ends of the stack of membranes 30 being provided an electrode compartment 18, 20 that convert the ionic current to an electrical current using a reversible redox reaction to enable powering electrical device 24 or using capacitive electrodes, for example. In use, compartments 12 are filled with electrolyte solution/solutions having low salt concentrations having low electrolyte concentrations, for example river water 16, with a relatively low osmotic pressure or value and/or electrolyte solutions/solutions with high salt concentrations having electrolyte concentrations higher than the low electrolyte concentrations, such as sea water 14, with a relatively high osmotic pressure value. High and low electrolyte concentrations are relative terms, and the relative relationship of the electrolyte concentrations provides the driving force for the ion transport through membranes 6, 8. When performing an ion-exchange process in a membrane based fluid-flow process, preferably the resistance of the membrane stack should be minimal, thereby requiring for instance a relatively small inter-membrane distance. Especially for a fluid compartment that is supplied with an electrolyte having a low concentration 16 this is very relevant. In addition, the membrane resistance also contributes significantly to the overall internal resistance and should preferably be as low as possible. When switching the flows between the compartments 12, the average inter-membrane distance can be optimized in time depending on the actual process that takes place in a specific compartment and performing an ion-exchange process. For example, by changing the (differential) pressure over a membrane, the average inter-membrane distance between the membranes 6, 8 defining the compartment can be varied. When having a large inter-membrane distance, the fluid flow is confronted with less hydraulic friction and a low pressure difference between the inlet and the outlet. In a compartment having a fluid/electrolyte with low concentration/low salt concentration, the inter-membrane distance is preferably reduced to decrease the electrical/ionic resistance of the (sub)-process and improve the power density of the overall process.

As an example, illustrated membrane stack 30 (FIG. 4) comprises two (AEM) membranes 42, one (CEM) membrane 44. Between membranes 42, 44 there is provided spacer module 46. In the illustrated embodiment spacer module 46 comprises a first open spacer 48, base/flow spacer 50, and second open spacer 52. Alternatively, spacer module 46 may comprise of only one base/flow spacer, wherein no open spacer is required. This configuration reduces complexity of the system, reduces cost, and reduces handling and stack building time. It will be understood that other configurations, including a range of dimensions, are also possible in accordance with the present invention, such as the application of different membrane thicknesses.

In the illustrated embodiment fluid supply system 54 comprises first inlets/outlets 56 and second inlets/outlets 58. In the illustrated embodiment open spacers 48, 52 are connected to one of the inlets/outlets 56, 58. It will be understood that another configuration according to the invention would also be possible without such connection wherein open spacers 48, 52 “only” have a bridging function providing additional support to the membrane and preventing membranes 42, 44 being pushed or sucked into one of the inlets or outlets of base/flow spacer 50. Furthermore, the use of another number of open spacers and/or base/flow spacers, for example three or four, in one spacer module 46 would also be possible according to the invention. This enables adjustment of the thickness of the spacer module and the compartments.

First configuration 50a (FIG. 5A) has relatively long fluid flow channels 60 extending between inlets and outlets 58, through-flow openings 56, and edges E₁ and E₂. Second configuration 50b (FIG. 5B) has smaller sized channels 62 and larger edges E₁ and E₂ resulting in a leakage reduction.

Different configurations for spacer module 46 are possible. Examples are shown in FIGS. 6 A-E. Other configurations may involve parallel co/counter flow. It is noted that inlets and outlets have been omitted from the drawings for illustrative purposes.

Spacer module 64 (FIG. 6A) comprises two open spacers 66 and flow-spacer 68. Spacer module 64 is a generic configuration of the embodiment illustrated in FIG. 4. Open spacer 66 has sealing part 70 and open part 72. Flow-spacer 68 has sealing part 74 and fluid flow (channel) part/compartment 76. As compared to the relatively simple configuration shown in FIG. 4, spacer module 64 is especially suitable for so called dynamic flow-spacer stack using flow spacers instead of conventionally used net-spacers. Spacer module 78 (FIG. 6B) has two open spacers 66 and base/flow spacer 80 with sealing edge 80a with porous flow compartment 82. Spacer module 84 (FIG. 6C) comprises two open spacers 86 with sealing part 88, open part 90 and porous inlet/outlet part 92, and flow spacer 80. Spacer module 94 (FIG. 6D) comprises two open spacers 66 and flow spacer 96 made by cutting, for example. When stacked, spacers 66, 96 provide assembly 98 for spacer module 94 that is especially useful in a so-called cross-flow stack configuration with four side plates that could be used in a RED process, for example. In fact, spacer modules 78, 84, 94 are especially suitable for a cross-flow stack with supply and discharge side-plates. It will be understood that other configurations and/or other combinations for a spacer module are also possible in accordance with the present invention.

In another embodiment according to the invention, in a so-called cross-flow stack (FIG. 6E) using supply and discharge side plates to direct the fluid flow streams, the fluid flow streams are directed to the sides of the membrane pile and thus no manifolds need to be cut into the membranes and spacers (see also FIG. 6B, C, D). For cross-flow stack with four supply and discharge side plates, flow spacer 100 has inlets/outlets 102 in the base/flow spacer frame enabling the supply/discharge of fluids in this particular stack. These inlets/outlets 102 of channels 104 in flow spacer 100 can be made on one or also on both sides. It should be clear that in combination with a number of open spacers 106 automatically a bridge-function is created. For example, two open spacers 106 can be applied in combination with one base/flow spacer 100. Such a flow spacer could be created, for instance by, but not limited to, (hot) embossing, thermoforming, injection moulding, 3D printing, CNC-machining etc.

Optionally, anti-ion shortcut current or anti-parasitic current edges are provided, preferably integrated with the spacer(s), and are made of non-ion conductive materials. The edges can be provided on one or two open spacers and/or on the flow spacer, for example. The embodiment with additional anti-ion shortcut current edges can be advantageously applied to a cross-flow stack with side plates for the fluid handling. The edges extend into the supply/discharge chambers of the side plates to block parasitic leakage. Preferably the edges have a width that is slightly larger than the depth of the side plate chamber for additional protection. Edges can be applied assymetrically, for instance only on the high salinity supply side, for example, or symmetrical on both sides. Further, optionally every five, ten or twenty cells there is provided such spacer with additional edges, for example. This enables the use side plates, in a cross-flow configuration with four side plates, that have a wider supply/discharge chamber, for example 5 mm in stead of 2 mm, thereby enabling an improved flow distribution and overal performance.

It will be understood that further modifications to the illustrated spacer components are possible. For example, the membranes can be provided with somewhat smaller, i.e. 1-5 mm, at the supply/discharge openings, especially in a cross-flow configuration with side plates to reduce hydraulic losses in the side plates. Also, manifold holes in the membranes can be made somewhat larger, i.e. 5-20% diameter increase as compared to the spacer holes, to reduce hydraulic losses, for example.

Experiments have been performed to illustrate the practical applicability of the invention. First, some bending measurements and estimations will be presented. Second, some experimental results will be shown.

Bending Calculations

In order to estimate the membrane bending behaviour, the membrane bending was estimated using simplified calculations according to the classical plate theory. The bending of a membrane is mainly depended on, in order of importance, the width of the compartment/channel, the membrane thickness, pressure applied (differential pressure) and the membrane mechanical properties (Young's Modulus E). The maximum bending/displacement, Wmax, can be estimated by

Wmax=C*Pressure*[(Width compartment)⁴]/[E*(thickness membrane³)].

The constant C depends on the width/length ratio of the compartment/channel, for example. The Young's Modulus for membranes is typically between 0.1-10 GPa, most often between 0.1-2 GPa. Using the equations, it can be estimated that under the experimental and/or practical conditions used, the bending is significant, even when the membranes are thick and/or have high Young's modulus. To illustrate the effect, the results of some calculations are given with corresponding assumptions and/or limitations.

Assuming a differential pressure of 1000 Pa (=10 mbar), Young's Modulus E=1 GPa, then for a 0.6 mm thick membrane, the max bending will be <1 micron in a channel with a width of 4 mm (for example, a channel in a flow-spacer), a length of 100 mm, and bending of more than 20 mm(!) when the width is 100 mm (for instance in the open spacer). It should be noted that the maximum displacement for a 0.14 mm thick membrane will be much higher. For such membrane, even in a relatively narrow channel with a width of 4 mm, the max bending is approximately 10-20 micron in this case. It should be understood that the pressure has a linear effect on the bending and the Young's modulus an inverse linear effect. Thus, even with a flow spacer as used in the experiment that will be described below, significant bending can be expected in the base/flow spacer. Thus, the dynamic process can be applied even without open spacer with only one flow spacer in case appropriately dimensioned flow spacers are used.

Experimental Results

A first RED experiment was performed using a 10×10 cm² flow-spacer stack similar as depicted in FIG. 4 with flow spacers as shown in FIG. 5B, and having ten cells comprising eleven Ralex CEM (type CM(H)-PES) and ten Ralex (type AM(H)-PES) AEM membranes of approximately 0.45 mm thick when dry (and approximately 0.6-0.75 mm when wet) in the spacer modules were used. The resistance of the membranes were on average approximately <8 Ohm cm². In use, one compartment was supplied with a salt solution of approximately 1 g/l NaCl (about 2 mS/cm) and the other compartment with a salt solution of approximately 30 g/l NaCl (about 49-51 mS/cm) at approximately 25° C. Titanium mesh based Ru/Ir-MMO electrodes were used. The electrode rinse solution comprising 0.05 M K₄ Fe(CN)₆ and 0.05 K₃ Fe(CN)₆ and 0.25M NaCl and was pumped around the electrode compartments with a flow rate of approximately 350 ml/min. The spacers were cut using a die-cutting knife from cheap LDPE foil of approximately 180 micron thick and having good tolerances. The membranes were cut also with a die-cutting knife. Resistance and power density was measured during various states of the dynamic and non-dynamic process using a potentiostat (Ivium). All experiments were corrected using a blank measurement with one CEM membrane, and the electrode compartments comprising the electrode rinse solution. In order to test the behavior of the flow-spacer stack and its spacers in non-dynamic process, a stack was built with three layers of flow-spacers with a total thickness of the spacer module being approximately 540 micron (see FIG. 5b). No back-pressure was applied. Both the Ohmic and non-Ohmic resistance were measured. The stack behaved very well and has a low pressure drop as expected of about 10 mbar because no net-spacers were used and instead the novel flow spacers according to the invention were used, thereby indicating that flow spacers have similar hydraulic properties as profiled membranes that are not very cost effective and not commercially available. The power density was about 0.19 W/m² at 654 ml/min, which is a good result with these high resistance Ralex membranes. In the flow rate range of 82-654 ml/min the Ohmic resistance remained approximately constant at approximately 10 Ohm, as expected the non-Ohmic resistance dropped from approximately 2 Ohm to 1 Ohm. The non-Ohmic resistance takes into account (diffusion) boundary layer phenomena. In this flow/rate range the OCV increased from about 1.26V to about 1.3V, and the power density increased from about 0.17 W/m² to 0.19 W/m². Even at such high flow velocity, there was no sign of bending of the membranes, i.e. dynamic behavior because the Ohmic resistance remained substantially constant with increasing flow velocity, which is a very strong indication that indeed no membrane bending occurs. The bending calculations support this conclusion. In another experiment performing a dynamic process with Ralex membranes, using a process similar as shown in FIG. 3b, the spacer module comprised one flow-spacer (see FIG. 5B) having on both sides an open spacer, similar as depicted in FIG. 4. A small back pressure was also used to create a differential pressure. A differential pressure of 10 mbar was achieved by increasing the flow rate of the highest salinity solution (here 30 g/l NaCl) with an extra 38 ml/min, thus ˜38 ml/min higher than the flow rate of the lowest salinity solution (here 1 g/l NaCL). Similar, a differential pressure of 15 mbar was achieved by increasing the flow rate of the highest salinity solution with an extra ˜57 ml/min. It should be noted, that, in general, a differential pressure can also be achieved with only using a back pressure, thus without changing the flow rates of the different solutions, and also, when flexible membranes and suitable open spacers are used, no back pressure is required and a differential pressure can be obtained by only changing the flow rates of the solutions, the flow rate of the high salinity solution being higher than the other solution.

In general, where applicable, in the graphs of the first RED experiment the averages are taken from each side of the flow-switch, and the values of both sides of the flow switch were very similar as could be expected. The effect of switch-time, thus the flow switch-frequency was also investigated over the range of 10-60 minutes. The resistance for all differential pressures AP was more or less constant with switch-frequency. The OCV however (not shown) dropped slightly when a differential pressure was applied, however, for ΔP=0 the OCV remained constant. Due to the small drop in OCV, the power density also dropped slightly with switch-frequency. It should be noted that the non-Ohmic resistance values for all differential pressures were quite similar, and remained approximately constant over the switch-time for all differential pressures (FIG. 7B). The Ohmic resistance dropped significantly when a differential pressure was applied (FIG. 7C), strongly indicating dynamic behavior. The power density even without differential pressure is about 0.26 W/m², which is significantly higher than when obtained with only flow spacers in previous experiment showing already the advantages of using open spacers in combination with flow-spacers The power density drastically increased from approximately 0.26 W/m² to 0.33-0.35 W/m² (FIG. 7D) when a differential pressure was applied. This clearly shows the positive performance of the dynamic process. From the resistance (FIG. 7A-C), it can be concluded that the flow-switch time has not a significant impact and it is expected that it doesn't significantly matters if one applies a flow-switch every 1 hour or every 24 hours, for example. Especially the resistance appears to be an important parameter to monitor and control the dynamic process. It can be seen, among others, from the stack resistance measurements in FIGS. 7A-C that, even with these thick and stiff membranes and relatively low differential pressures (<=15 mbar) used in the experiment, that a significant bending can be observed. This means that with dynamic process a lower resistance was obtained than without significant bending, thereby proving the applicability of a controlled dynamic process.

The experiment shows that the stack performs best at the average differential pressure at the inlets and outlets between 10-15 mbar, the differential pressure at the inlet is slightly lower than at the outlet, the Ohmic resistance drop between 18-24% during dynamic stage while the non-Ohmic resistance remained constant, the results after (flow)switch from side 1 to 2 are very similar when the same needle valve is used, and the OCV and resistance slightly drop with longer switch time during dynamic stage.

A second RED experiment was performed similar to the first experiment, however with the use of thinner membranes. A set-up as shown in FIG. 3B was applied. In a flow-spacer stack of 10×10 cm², 10 cells, NEOSEPTA CMX and AMX membranes of approximately 0.14-0.17 mm thick were used, AMX being about 0.14 mm dry. The OCV, resistance and power density were measured during various states of the dynamic and non-dynamic process. In general, similar results were obtained as previous experiment with Ralex. The main difference is the lower Ohmic resistance and, higher OCV and thus higher power density, which can be attributed to the better specifications of these NEOSEPTA membranes. It can be seen, among others, from the stack resistance measurements that with these membranes significant bending can be observed even at very low differential pressures. This means that with dynamic process a lower resistance was obtained than without significant bending, proving the controlled dynamic process. With these, thinner, membranes the dynamic behavior can even be observed with not even applying significant back pressure and only controlling the dynamic behavior by adjusting flow rates. More specifically, when studying the effects of switch-time with varying differential pressures with NEOSEPTA membranes (FIG. 7E), higher power densities were obtained. The power density without differential pressure was approximately 0.52 W/m² and with differential pressures 10-15 mbar gave very similar results ranging from approximately 0.64-0.68 W/m². From FIG. 7E it can be clearly seen that the Ohmic and total resistance using NEOSEPTA membranes is significantly lower, due to the better specifications of the NEOSEPTA membranes.

A third RED experiment was performed using a large 22×22 cm² RED cross-flow stack with four side plates distributing the fluids with N=504 using real pretreated surface water on a pilot test site, the effect of special spacers were tested, with configuration as illustrated in FIG. 6B to test reduction of ionic short cut current losses, more specifically with configurations similar as flow spacer 80 as illustrated in FIG. 6B, and including the anti-parasitic current edges on edges 80a to test reduction of ionic short-cut current losses. After every 21 cells, a special spacer was used which separates the manifold side-plate and thus significantly reducing ionic-shortcut currents. From model-calculations, applying equivalent electrical circuit calculations, it can be shown by these calculations that the ionic-shortcut losses are larger when the membrane pile gets larger, thus a stack with N=21 cells has much less losses than a stack of N=504 cells. It should be noted that by manifolding all the 24 compartments, some extra short-cut losses can be expected. However when designing such that the flow path has a significant length, and thus high resistance, these losses are relatively small Taking into account the required space, two similar stacks were compared, with the main difference the separation. Under the experimental conditions when using these special ‘separator spacers’ (which are similar as the spacer shown in FIG. 6B-E, but then with a part of the sealing edge on at least one, and preferably two sides extending in the manifold flow distributer side plates, the OCV and stack resistance increased with approximately 20-25%, and the power density improved with approximately 10%. Especially at low flow rates, when the resistance of the membrane stack is relatively lower, the stack performed best. In order to enhance the effect of the separator/divider spacers on the performance, the internal membrane stack resistance should be as low as possible and/or the ratio of the resistance of ionic shortcut current path over the membrane stack resistance should be as high as possible, for instance by using very low-resistance membranes and/or making manifold dimensions as small as hydraulically possible and/or increasing the effective surface area of the membranes, thus instead of a 22×22 cm² stack, it's better to use a 44×44 cm² stack with regard to lowering the ionic-short current losses and improving performance. It should be noted, these type of separator, ionic-short cut current reducing spacers can especially, if not only, be applied in the so called cross-flow stack using four distribution side plates.

In addition, assuming Ralex membranes, and sensitive to parameters such as membrane resistance, salinity of the flows, inlets/outlets manifold dimensions, membrane surface are, spacer module configuration, process conditions etc, some calculated and indicative results, including electric equivalent circuit calculations for example, are included in the table below, showing the relative influence of cell number and stack dimensions. For a larger stack the stack resistance is lower, thus reducing the ion short cut losses. It is noted that the power density-yield is a measure ionic-short cut losses, thus 100% is no losses at all.

TABLE
Stack comparison

| | Power density-yield (%) | Power density-yield (%) |
|---|---|---|
| N | 10 × 10 cm2 stack | 22 × 22 cm2 stack |
| 2 | 98.7 | 99.8 |
| 5 | 95.7 | 99.1 |
| 10 | 88.4 | 97.4 |
| 20 | 74.1 | 92.4 |
| 50 | 55.4 | 79.2 |
| 100 | 48.1 | 70.8 |

The table clearly shows the effect of the number of cell pairs (N), with increasing N the ionic short cut losses increase rapidly, especially for 10×10 cm² stack, and starts to flatten out at approximately N>50.

In a further application, the device and method is tested for (cross) filtration, for instance for microfiltration, ultrafiltration and nanofiltration processes. Such a device is also known as a plate- and frame cross-flow filtration unit. Here fluid A is fed into the device and leaves as fluid C, the so-called retentate. The retentate is often recycled back into the feed, often via a buffer tank. Fluid B, the so-called permeate, is transferred through the membrane and exits the stack at least at one side thereof. A typical average feed flow velocity in the flow channel is 0.01-10 m/s, preferably 0.1-5 m/s. In general, a higher flow velocity in cross-flow filtration helps to reduce fouling of the membrane surface. For cross-flow filtration according to the preferred embodiment of this invention, the membrane has to be flexible to be able to perform the dynamic process as described in relation to FIG. 2 A-B. Cross-flow filtration device according to this invention is also, but not limited, very useful as a high-volume pre-filtration device for ED, EDR and RED. Especially for RED pre-filtration has to be energy efficient. For example, this can be illustrated with a calculation. Using a cross-flow stack with 500 cells (=1000 spacer modules) and a total effective membrane area of 280 m², the feed containing 0.2 g/l solid material (suspension), typical for surface water, the resulting flow rate is 10001/min. Assume 50% of feed is recycled, thus permeate flow is 5001/min, then the calculated footprint of such as stack is approximately L×B×H=0.5×0.5×1.2 m, thus very small. Pressure drop in flow compartment is less than 10 mbar when flow spacers with flow channels are used. The calculated pumping energy, assuming a pump efficiency of approximately 75%, is less than 50 W. Assuming that a backwash is needed after the membrane is fouled with a layer of 20 micron thick, then under these conditions every approximately 56 minutes a back-wash is required. The low pressure drop, low back-flush frequency, overall low energy consumption, and small footprint render the performance of such as stack is thus very (economically) competitive as compared with conventional filtration devices, such as drum-filters.

Another experiment was performed to investigate the (fouling) performance of the dynamic stack when real sea water and lake/river water was used at REDstack's research facility at the Afsluitdijk, The Netherlands. This experiment shows the effectiveness of the dynamic stack with actively controlled membrane distances to reduce and/or prevent fouling and therefore improving overall performance.

The experiment was performed with a dynamic flow spacer stack, similar as the first and second experiment with 10 cell pairs comprising flow spacers as described in FIG. 5b and open spacers schematically similar as described in FIG. 6a. The spacer module was thus very similar as described in FIG. 4. Both flow spacer and open spacers were cut from thin LDPE foil of approximately 180 micron using a special die-cutting knife. Titanium plate electrodes with a Ru/Ir-MMO coating were used. The electrode-rinse solution comprising 0.05 M K₄Fe(CN)₆ and 0.05 K₃FE(CN)₆ and 0.25 M NaCl was used which was pumped around the electrode compartments with a flow rate of approximately 350 ml/min. NEOSEPTA membranes (type CMX and AMX) were used. In use, one compartment was supplied with river/lake water with a salt concentration of approximately 0.4 g/l (conductivity fluctuated starting at around 0.8 mS/cm and around 0.9 mS/cm after 20 days). And the other compartment with real sea water of approximately 30 g/l (conductivity fluctuated starting around 45 mS/cm and around 50 mS/cm after 20 days). It should be noted that real sea and river/lake water contains not only NaCl but many other salts and impurities, which in general, lower the overall performance Due to the fact it's real sea water and lake/river water the concentrations/conductivities and temperature fluctuate over time, with the temperature starting round 13 degrees ° C. and at the end after 20 days around 16 degrees ° C. Furthermore, it should be noted that the temperature significantly effects the performance due to its effect on the resistance (thus, lower temperature results in a higher resistance), thus with every temperature difference of 1 degree ° C., the performance measured as power density changes with approximately 3% to the reference at 20° C. Resistance and power density were measured during various states of the dynamic and non-dynamic process using a potentiostat (Ivium). All data were analysed using a custom-made Matlab script. To keep track of the experiment during the weekends and the evenings, the program Teamviewer was used. The measurement of resistance is important because it is a perfect measure of the dynamic bending process directly showing if the inter-membrane distance changes (thus being dynamic) when a differential pressure between the compartments is applied in a controlled and active manner; a lower resistance therefore indicates that the membrane is actively pushed into the compartment with the lower conductivity solution. Pressure meters were used to measure the pressures drop and pressure difference (differential pressure) in the stacks. The pressure drop is also a strong indicator for dynamic behavior. Thus if the (average) pressure drop increases when a pressure difference between the low concentration (river water) and high concentration (sea water) compartments is applied the membrane bend into the low concentration compartment thus making the compartment thinner which drastically increases the pressure drop because pressure drop scales with (thickness)⁻³. The average pressure drop of river and sea water is shown in FIG. 8c.

Two identical stacks were built and compared, one reference stack (1) being operated in non-dynamic mode and one stack (2) being operated in the dynamic mode. In the non-dynamic stack (1) no differential pressure between low concentration and high concentration compartment was actively applied. Due to intrinsic pulses of the hose pump, a small differential pressure might be applied in a non-active and non-controlled manner, but this effect approximately averages out thus making this stack on average non-dynamic. A flow switch, switching the lake water and sea water, was applied every 30 minutes for both stacks throughout the experiment. The flow-switches were applied using electronic 3-way valves which were controlled using a Raspberry Pi control-unit.

An experimental set-up similar as shown in FIG. 3b was used. The differential pressure for the dynamic stacks was set to 10 mbar.

After the experiment the stacks were dismantled to investigate the fouling inside the stacks visually. As expected, more fouling, especially at the inlets, was observed in the non-dynamic stack.

Due to some broken valves the experiment was interrupted (around day 6 in FIG. 8), which are shown in the graphs as omission of data points, but effected the results only temporarily. FIG. 8a clearly shows the non-dynamic stack 1 had the highest total resistance because the thickness of the river compartment was thicker than of the dynamic stack (2) because the stack was not operated in a dynamic mode, ie, the membrane was not actively pushed into the river water compartment by the actively applied differential pressure, which change of inter-membrane distance. The dramatic difference in resistance between stack 1 and 2 shows clearly that the membranes are actively pushed into lower concentration compartment decreasing the thickness and hence the resistance.

FIG. 8b clearly shows that the dynamic stack (2) performs better than the reference non-dynamic stack (1) during the whole experiment thus also showing the fouling is actively prevented/removed due to the dynamic process. The fluctuations in power density can most likely be explained by fluctuations in concentrations and temperature.

In FIG. 8c, depicts the average pressure drop of non-dynamic and dynamic stack, clearly showing that the pressure drop of the dynamic stack is higher due to the membrane being pushed into the low concentration compartment drastically increasing the pressure drop. Furthermore, it can be clearly seen from FIG. 8c that over time the average pressure drop increases for the non-dynamic stack, while the pressure remains on average rather constant for the dynamic stack, strongly indicating that in the dynamic mode the fouling is being significantly prevented/removed.

It can be concluded from the shown data that operating the stack in a dynamic mode, thus actively changing the inter-membrane distance by applying a differential pressure in a special designed spacer module according to the invention, the performance was much approved because fouling was actively prevented and/or removed while operating with a thin lake (low-concentration) water compartment for enhancing the power by lowering the resistance.

The present invention is by no means limited to the above described and preferred embodiments thereof. The rights sought are defined by the following claims within the scope of which many modifications can be envisaged.

1. Method for fouling reduction and/or fouling removal and/or prevention of fouling in membrane based fluid-flow processes, comprising the steps of:
providing a dynamic membrane stack with a number of membranes, the stack capable of changing the average inter-membrane distance between two adjacent membranes with the inter-membrane distance being the distance between the membrane surfaces of two adjacent membranes;
performing the membrane based fluid-flow process in a first state with the stack having a first set of average inter-membrane distances;
switching the membrane based fluid-flow process between the first state and a second state wherein the stack having a second set of average inter-membrane distances different from the first set; and
performing the membrane based fluid-flow process in the second state, wherein, at least in an initiating phase, fouling is removed and/or reduced and/or prevented.

2. Method according to claim 1, wherein switching between the first and the second state comprises performing a flow-switch switching the fluids through the inter-membrane distances and/or flow reversal reversing the direction of the flows.

3. Method according to claim 1, comprising the step of providing a differential pressure over a membrane, by providing a pressure difference between adjacent compartments that are separated by the membrane, in the range of 0.1-500 mbar, preferably 0.1-100 mbar, more preferably 0.1-50 mbar, and most preferably 0.1-25 mbar.

4. Method according to claim 1, wherein, in use, switching is performed in a time interval of 0.1-180 hrs, preferably 2-48 hrs, most preferably 4-24 hrs.

5. Method according to claim 1, wherein, in use for filtration processes, the switching is performed in a time interval of 0.01-168 hrs, preferably 0.1-48 hrs and most preferably 0.2-24 hrs.

6. Method according to claim 1, wherein the membrane based fluid-flow processes comprise electro-membrane processes.

7. Method according to claim 6, further comprising the step of providing a stack configuration comprising a spacer module capable of handling varying average inter-membrane distances.

8. Device for performing a membrane based fluid-flow process, wherein the device is capable of performing the method according to one or more of the foregoing claims.

9. Device according to claim 8, further comprising a dynamic membrane stack having a number of membranes, wherein the stack is configured for enabling a change of the inter-membrane distance between two adjacent membranes.

10. Device according to claim 7, further comprising a spacer module configured for enabling varying the average inter-membrane distance.

11. Device according to claim 10, wherein the spacer module between two adjacent membranes comprises a flow spacer and at least one additional open spacer.

12. Device according to claim 11, wherein the spacer module comprises two open spacers.

13. Device according to claim 11, wherein the open spacer comprises a bridge-element.

14. Device according to claim 10, wherein at least some of the membranes are profiled membranes.

15. Device according to claim 12, wherein the open spacer comprises a bridge-element.

16. Device according to claim 9, further comprising a spacer module configured for enabling varying the average inter-membrane distance.

17. Method for fouling reduction and/or fouling removal and/or prevention of fouling in membrane based fluid-flow processes, comprising the steps of:
providing a dynamic membrane stack with a number of membranes, the stack capable of changing the average inter-membrane distance between two adjacent membranes with the inter-membrane distance being the distance between the membrane surfaces of two adjacent membranes;
performing the membrane based fluid-flow process in a first state with the stack having a first set of average inter-membrane distances;
switching the membrane based fluid-flow process between the first state and a second state wherein the stack having a second set of average inter-membrane distances different from the first set;
performing the membrane based fluid-flow process in the second state, wherein, at least in an initiating phase, fouling is removed and/or reduced and/or prevented; and
providing a differential pressure over at least one of the membranes.

18. Method according to claim 17, wherein, in use, switching is performed in a time interval of 0.1-180 hrs, preferably 2-48 hrs, most preferably 4-24 hrs.

19. Method according to claim 17, wherein, in use for filtration processes, the switching is performed in a time interval of 0.01-168 hrs, preferably 0.1-48 hrs and most preferably 0.2-24 hrs.

20. Method according to claim 17, further comprising the step of providing a stack configuration comprising a spacer module capable of handling varying average inter-membrane distances.
